(19) United States
(12) Patent Application Publication
(10) Pub. No.: US 2020/0005279 A1
(43) Pub. Date: Jan. 2, 2020

(54) SYSTEM AND METHOD FOR PROXIMITY BASED WALLET NOTIFICATIONS

(71) Applicant: JPMorgan Chase Bank, N.A., New York, NY (US)

(72) Inventors: Joe RAQUEPAW, Delaware, OH (US); Michael THORNTON, Westerville, OH (US); Matthew JUDY, Dublin, OH (US)

(21) Appl. No.: 16/023,415

(22) Filed: Jun. 29, 2018

(51) Int. Cl. G06Q 20/36; G06Q 20/10

(52) U.S. Cl. CPC G06Q 20/367; G06Q 20/1085

(57) ABSTRACT

The invention relates to a mobile device that performs the steps of: identifying a signal transmitted from a beacon associated with an ATM, the signal indicating that the mobile device is within a predetermined proximity to the ATM; responsive to the signal, providing a notification to a customer that an ATM is within the predetermined proximity; requesting one or more card instruments from the digital wallet application; receiving at least one card instrument that is eligible to interact with the ATM; automatically presenting the at least one card instrument on a display interface; and activating of the at least one card instrument for interaction with the ATM.

### FIELD OF THE INVENTION

The invention relates generally to a system and method for proximity based notifications, and more particularly to a system and method for providing proximity based electronic wallet notifications for interaction with a nearby financial services machine, such as an ATM.

### BACKGROUND OF THE INVENTION

Mobile banking technology allows customers to conduct numerous financial transactions through a mobile device. For instance, customers can use a mobile device to check account balances, pay third parties, and perform funds transfer. Because of the convenience, more and more customers are moving their physical cards to digital wallet applications on their mobile devices. Along with this convenience, consumers experience the hassle of identifying the right card to use at the right time. In particular, ATMs, banking kiosks, tellers, point of sale devices and other similar devices do not offer a convenient process to interact with digital wallet applications executing on mobile devices.

These and other drawbacks currently exist.

### SUMMARY OF THE INVENTION

According to one embodiment, the invention relates to a mobile device comprising: a memory component that stores customer data; an application that executes on the mobile device that accesses a digital wallet application; a display interface that receives customer input and generates display data; and a microprocessor, coupled to the memory component, the display and the application. The microprocessor of the mobile device is configured to perform the steps of: identifying a signal transmitted from a beacon associated with an ATM, the signal indicating that the mobile device is within a predetermined proximity to the ATM; responsive to the signal, providing a notification to a customer that an ATM is within the predetermined proximity; requesting one or more card instruments from the digital wallet application; receiving at least one card instrument that is eligible to interact with the ATM; automatically presenting the at least one card instrument on the display interface; and activating of the at least one card instrument for interaction with the ATM.

The method may be conducted on a specially programmed computer system comprising one or more computer processors, mobile devices, electronic storage devices, and networks.

The invention also relates to method for implementing a mobile device application executing on a mobile device for proximity based digital wallet notifications. The method comprises the steps of: identifying a signal transmitted from a beacon associated with an ATM, the signal indicating that the mobile device is within a predetermined proximity to the ATM; responsive to the signal, providing a notification to a customer that an ATM is within the predetermined proximity; requesting one or more card instruments from the digital wallet application; receiving at least one card instrument that is eligible to interact with the ATM; automatically presenting the at least one card instrument on a display interface; and activating of the at least one card instrument for interaction with the ATM.

The computer implemented system, method and medium described herein can provide the advantage of realizing a convenient solution to customers interacting with financial services machines, such as ATM devices. For customers with multiple cards loaded in a digital wallet, an embodiment of the present invention automatically identifies an appropriate debit card as the customer approaches an ATM device. With the innovative technology, the customer's mobile device may present a notification so that when the customer interacts with the notification, a corresponding debit card is ready for ATM interaction. This provides a timely launch and display of the debit card for immediate interaction with the ATM. The present invention will avoid the situation where customers experience an error message when attempting to use an ineligible card stored in the customer's digital wallet. The innovation achieves customer loyalty and retention due to the increased satisfaction of the account holder. The system provides convenience, time efficiencies, and security for customers as they interact with various financial devices. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram of a system for implementing a proximity based wallet, according to an exemplary embodiment of the invention.

FIG. 2 is an exemplary diagram of a method for implementing a proximity based wallet, according to an embodiment of the present invention.

FIG. 3 is an exemplary diagram of a method for implementing a proximity based wallet, according to an embodiment of the present invention.

FIG. 4 is an exemplary screenshot illustrating a proximity based wallet interface, according to an embodiment of the present invention.

FIG. 5 is an exemplary screenshot illustrating a proximity based wallet interface, according to an embodiment of the present invention.

FIG. 6 is an exemplary screenshot illustrating a proximity based wallet interface, according to an embodiment of the present invention.

FIG. 7 is an exemplary screenshot illustrating a proximity based wallet interface, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to proximity based technology that notifies a customer when the customer is near an ATM (or other financial services machine) and further prompts a launch of the customer's digital wallet with an appropriate debit card activated and ready to interact with the ATM. According to an exemplary embodiment, an ATM may be outfitted with a Bluetooth Low Energy (BLE) beacon which transmits certain parameters, values, etc. Parameters may include universally unique identifier (UUID) and Major and Minor values that represent numbers assigned to a particular beacon to facilitate beacon identification with greater accuracy. A target application executing on a mobile device may listen for beacons with specific UUID, Major, Minor and in response, trigger actions when in range of a matching signal.

An embodiment of the present invention is directed to providing customer notification using wireless, contactless, near field, radio and other communication technology. For example, an ATM with a reader (that supports wireless communication including NFC (near field communication), BLE (Bluetooth low energy) WiFi, LTE, etc.) can interact with a customer using a mobile phone or other device. Other technologies may include geofencing and other location-based solutions.

The following descriptions provide different configurations and features according to exemplary embodiments. These configurations and features may relate to providing financial services through financial services machines. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any combination as is within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

“Financial transaction machine” or “financial transaction device” as used herein, may include machines, devices, kiosks, and stations, each of which may be fixed or portable, for performing financial transactions with a financial institution. For example, financial transaction machines may include, but are not limited to, express banking kiosks (“EBKs”), automated teller machines (“ATMs”), personal teller machines (“PTMs”), financial self-service devices, financial services kiosks, financial transaction devices, portable electronic devices, money machines, cash machines, bank machines, and bancomats. Financial transaction machines may be located within or near a branch of a financial institution, a retailer, a merchant, or other public location. It should be appreciated that, while various exemplary embodiments are described herein in terms of an EBK, these descriptions are meant to be non-limiting and equally applicable to other forms of financial transaction machines. The financial transaction machine may be operated by a financial institution.

The term “financial institution,” as used herein, may include institutions that provide financial services to their members or customers. Financial institutions may include, but are not limited to banks, credit unions, trust companies, mortgage loan companies, insurance companies, investment banks, underwriters, and brokerage firms. The use of the term “bank” and “financial institution” herein is meant to be exemplary and non-limiting.

The term “customer,” as used herein, may refer to an individual who holds at least one account with the financial institution.

Exemplary embodiments provide methods and systems for conducting financial transactions with a financial transaction machine. A mobile application, such as one provided by a financial institution with which the customer has an account, may be used. The mobile application may be installed on a portable electronic device, such as a tablet, smartphone, wearable, etc. According to an exemplary embodiment, the customer may perform various banking and other functions using the mobile application.

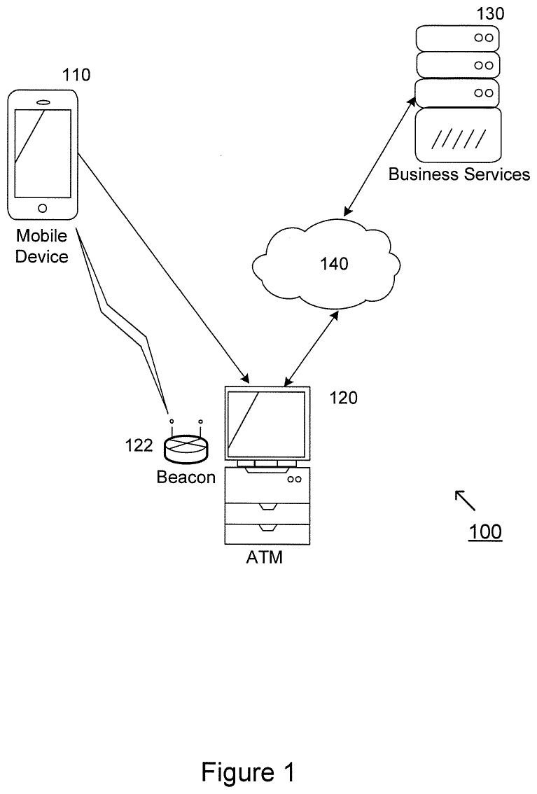

FIG. 1 is a diagram of a system for implementing a proximity based wallet, according to an exemplary embodiment of the invention. As shown in FIG. 1, Mobile Device 110 may represent a customer's mobile device with a custom application (“app”) installed. The custom app may be responsible for listening for a broadcast from a beacon. Beacon 122 may be integrated or otherwise associated with an ATM 120 or a plurality of ATMs. Beacon 122 may be responsible for broadcasting a wireless signal indicating that an ATM device is nearby (or within a predetermined distance or radius). ATM 120 may include beacon and NFC login capabilities. ATM 120 may communicate with Business Services 130 via a network, such as Network 140. Business Services 130 may represent a platform provided by a financial institution, bank, service provider, etc.

As illustrated, Network 140 may be communicatively coupled with one or more data devices including, for example, ATM 120, and indirectly with a customer mobile device 110. Network 140 may communicate with various other devices including other financial services machines, mobile devices, smart devices, servers, databases and point of sale devices. The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

The Network 140 may be a wireless network, a wired network or any combination of wireless network and wired network. Although the Network 140 is depicted as one network for simplicity, it should be appreciated that according to one or more embodiments, the Network 140 may comprise a plurality of interconnected networks, such as, for example, a service provider network, the Internet, a cellular network, corporate networks, or even home networks, or any of the types of networks mentioned above. Data may be transmitted and received via Network 140 utilizing a standard networking protocol or a standard telecommunications protocol.

While FIG. 1 shows a single ATM 120 and Mobile Device 110, it should be appreciated that there may be several of such devices to carry out the various exemplary embodiments. For example, ATM 120 may represent several EBKs, any one of which may be used to practice the various exemplary embodiments. Again, the use of EBKs is meant to be non-limiting and, may include, but are not limited to, automated teller machines (“ATMs”), personal teller machines (“PTMs”), financial self-service devices, financial services kiosks, financial transaction devices, portable electronic devices, money machines, cash machines, bank machines, and bancomats, for example. The financial transaction device 110 may be associated with and/or operated by a financial institution. The financial transaction machine may be connected directly with the financial institution, or indirectly using a payment network, processor, or gateway.

ATM 120 may comprise, for example, a display, which may be touch-sensitive or otherwise; an alpha-numeric and/or QWERTY keyboard, either physical or virtual, for receiving input; a pointing device, such as a trackball, track wheel, or mouse, for example; a scanning camera to scan items displayed or presented by customers; a cash dispenser; a check and/or cash receiver; a printer, such as for printing receipts, for example; a biometric scanner, such as a fingerprint or retinal scanner; and communication chipsets for communicating with other devices, such as Mobile Device 110, directly or via Network 140, for example.

ATM 120 may also include a reader (e.g., NFC, BLE, WiFi, LTE, etc.) to establish wireless communication with mobile devices. Other forms of wireless, contactless and radio communications may be supported.

Mobile Device 110 may be associated with a customer. The customer may have one or more accounts with the financial institution that operates the ATM 120 or other financial transaction machine. Mobile Device 110 may alternatively represent various user devices, such as a laptop computer, a personal digital assistant, a smartphone, a smartwatch, smart glasses, other wearables or other computing devices capable of sending or receiving network signals. Mobile Device 110 may have an application installed that is associated with the financial institution or a third party service provider.

Business Services may be executed on various computer components, such as a server that performs operations associated with processing information and data associated with ATM 120 and other financial transaction devices and/or Mobile Device 110. Business Services 130 may execute on one or more servers and/or computers, each having one or more computer processors associated therewith. In various exemplary embodiments, the server may be a specific computing device to support exemplary embodiments as described herein. Business Services 130 may be communicatively coupled with various memory components, such as databases, data stores, data centers, cloud storage, etc. The memory components may include any suitable data structure to maintain the information and allow access and retrieval of the information.

Having described an example of the hardware, software, and data that can be used to run the system, an example of the method and customer experience will now be described. The method will be described primarily as an example in which a customer downloads a software application (sometimes referred to as an “app”) and uses it to perform banking transactions and/or other functionality, including making purchases. However, those skilled in the art will appreciate that the principles of the invention can be applied to related circumstances, such as where the entity providing the app is a business other than a merchant, or where the merchant app functionality is provided through a browser on the customer's mobile device rather than through a software application (app) downloaded to the customer's mobile device, and with purchases from various providers.

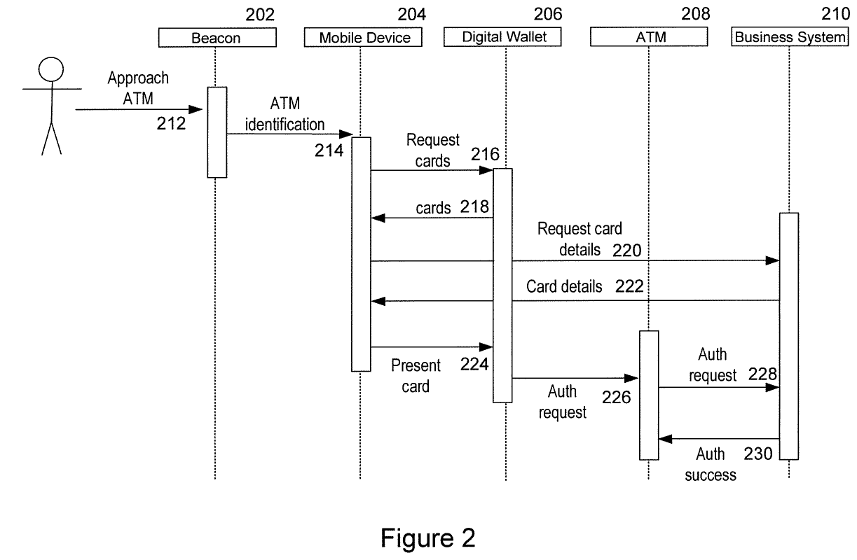

FIG. 2 is an exemplary diagram of a method for implementing a proximity based wallet, according to an embodiment of the present invention. FIG. 2 illustrates interactions between and among various components of the present invention. A system of an embodiment of the present invention may include Beacon 202, Mobile Device 204, Digital Wallet 206, ATM 208 and Business System 210. Beacon 202 may be integrated or otherwise associated with ATM 208. Digital Wallet 206 may be in the form of a mobile application executing on Mobile Device 204. Mobile Device 204 may represent a mobile phone, smart device, personal digital assistant, wearable and/or other customer device. Business System 210 may represent services provided by an entity, e.g., financial institution, bank, service provider, etc. ATM 208 may represent a financial services machine, such as an ATM, terminal, kiosk and/or other financial device.

At step 212, a customer may approach an ATM at a distance that indicates that it is likely the customer plans to interact with the ATM. At step 214, the ATM may be identified by a Mobile Device. The Mobile Device may display a notification to the customer. The ATM may continuously broadcast a Bluetooth Low Energy signal (Beacon) announcing it is active and supports NFC based login. The customer's mobile device may pick up the signal and trigger an application to activate. At step 216, the application on the mobile device may make a request to a Digital Wallet software on the device requesting one or more stored cards. At step 218, the Wallet may return one or more card tokens and related information. At step 220, the application may send the card tokens to a business service platform where the token may be matched with the card data. At step 222, the service may return the card type and a graphic associated with each specific card. At step 224, the application may send a request to the Digital Wallet software on the mobile device to present the appropriate card for an NFC payment. At step 226, the mobile device may be held against the NFC reader on the ATM and transmit the appropriate tokens. Other forms of interaction and proximity technology may be implemented. At step 228, the ATM may transmit the token to the business service requesting authorization. At step 230, the business service may send a message to the ATM to authorize the ATM for the card that was presented. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed.

An embodiment of the present invention is directed to detecting a customer device's proximity to financial services device (e.g., ATM, terminal, point of sale device, etc.), by establishing a communication channel based on close proximity between the customer device and the financial services device. The communication channel may involve near field communication, low energy proximity sensing, beacons, sensors, wireless technology, etc. For example, mobile devices may broadcast a signal, an identifier and/or other information to a nearby receiving device. This enables mobile devices, tablets, wearables, etc. to perform actions and/or communicate when in close proximity to a receiving device or terminal. The connectivity may be established by various technologies, including proximity sensing, wireless and/or other communication technologies. For example, an ATM device may communicate with a customer's mobile device for proximity detection and then enable the customer to perform a set of functions.

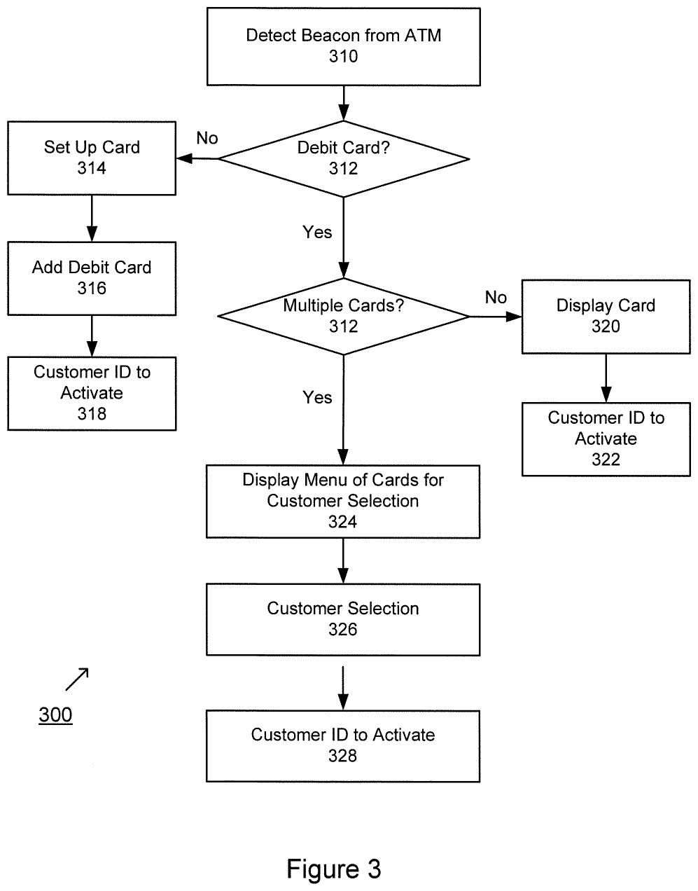

FIG. 3 is an exemplary diagram of a method for implementing a proximity based wallet, according to an embodiment of the present invention. At step 310, a signal may be detected by an application running on a mobile device associated with a customer. At step 312, the application may determine whether a debit card exists. If not, the application may initiate a set-up process at 314 where the customer may add a debit card at 316. Once the debit card is active, the customer may activate the card via a customer identifier or other authentication, at step 318. If a debit card exists, the application may determine whether there are multiple cards, at step 312. If not, the single debit card may be displayed on the mobile device at 320. The customer may then activate the debit card for interaction with the ATM device, at step 322. If multiple cards exists, the application may display a menu of cards for customer selection at step 324. The customer may provide a selection or allow the application to proceed with a default or preferred card, at step 326. The customer may then activate the selected card at step 328. The customer may then interact with the ATM or other financial services machine. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

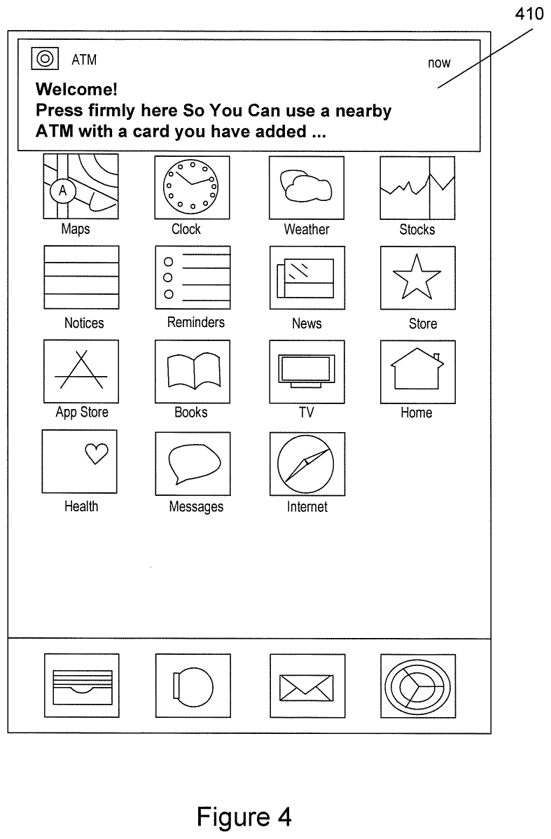

At step 310, a signal may be detected by an application running on a mobile device associated with a customer. The signal may be detected from a beacon associated with an ATM device. Other signal detecting technology may be implemented. FIG. 4 is an exemplary screenshot illustrating a proximity based wallet interface, according to an embodiment of the present invention. FIG. 4 illustrates a message notification that is displayed to a customer as the customer approaches an ATM and a signal is detected. Other technologies for detecting a mobile device may be implemented, including geofence and other location-based technology.

At step 312, the application may determine whether a debit card exists. By interacting with the notification, the application may then launch a debit card in the digital wallet.

If a debit card does not exist, the application may initiate a set-up process at 314 where the customer may add a debit card at 316. For example, the customer may select a set-up process where a customer may add cards to the customer's digital wallet. This may involve taking an image of a physical card or accessing/retrieving card information from another source.

Once the debit card is active, the customer may activate the card via a customer identifier or other type of authentication, at step 318. For example, the customer may provide a touch ID, facial recognition, password and/or other forms of authentication. Moreover, additional security parameters may be implemented. If the ATM is recognized as a new ATM (e.g., the customer has not interacted with this particular ATM before), additional authentication may be requested. Also, if the customer is in a new location (e.g., travel; outside of home and work zones), additional security may be applied. For example, the customer may be requested to provide an additional form of authentication, which may include a biometric, a PIN, password, alias, zip code, last four digits of a social security number, security question, and/or other information. A biometric may be provided in various ways, including the customer placing his or her finger on the mobile phone's fingerprint reader, for example. Other forms of biometric or other methods of verifying identification or authentication may be implemented. In contrast, if the ATM is recognized as one that the customer frequently uses (and further fits within the customer's history or pattern), additional security may not be requested.

If a debit card exists, the application may determine whether there are multiple cards, at step 312. If not, the single debit card may be displayed on the mobile device at 320. The customer may then activate the debit card for interaction with the ATM device, at step 322. As described in connection with step 318, additional authentication may be requested.

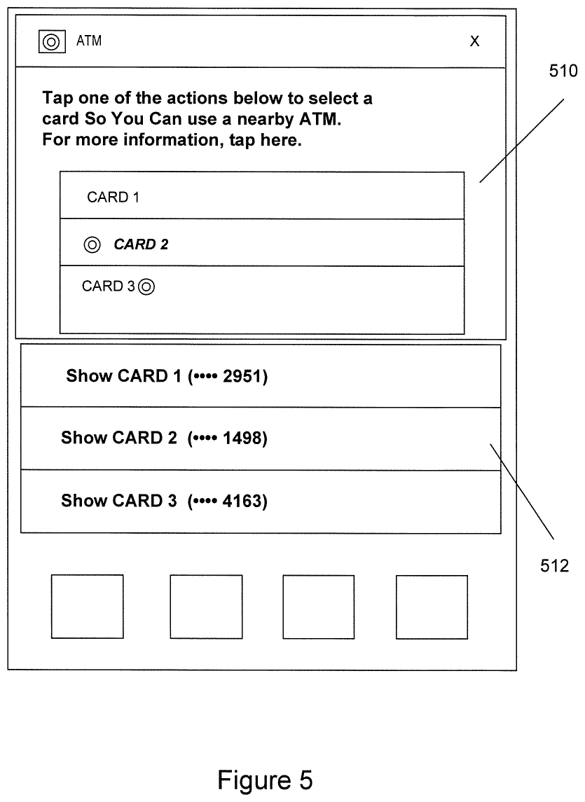

If multiple cards exists, the application may display a menu of cards for customer selection at step 324. FIG. 5 is an exemplary screenshot illustrating a proximity based wallet interface, according to an embodiment of the present invention. If multiple eligible cards exist in an electronic wallet, the mobile device may display each card at 510 and further enable the customer to select one for interaction, at 512, with the nearby ATM. While multiple cards may be stored on a digital wallet application of the customer's mobile device, the menu may display a subset of eligible cards for ATM interaction. The menu may also display other instruments that can be used to interact with an ATM, such as tokens, single use passcodes, QR codes and/or other mechanisms that authorize interaction with an ATM. In addition, the customer may assign a preference or priority to the selection process so that a desired payment instrument is presented for a particular use, ATM, time period, etc.

The customer may provide a selection or allow the application to proceed with a default or preferred card, at step 326. According to an exemplary illustration, the system may recognize a customer's preference of cards at a specific ATM, location, region, etc. The system may also recognize a customer's preference and historical data based on time of day, day of the week, and/or other schedule. The customer may be part of a household where one member prefers a first debit card and another member prefers an different card. Other customer preferences, usage patterns and/or other historical data may be recognized. In these examples, the application may automatically present a preferred (or likely preferred or even suggested) card for use with a specific ATM.

The customer may activate the selected card at step 328. As described in connection with step 318, additional authentication may be requested. The customer may then interact with the ATM or other financial services machine.

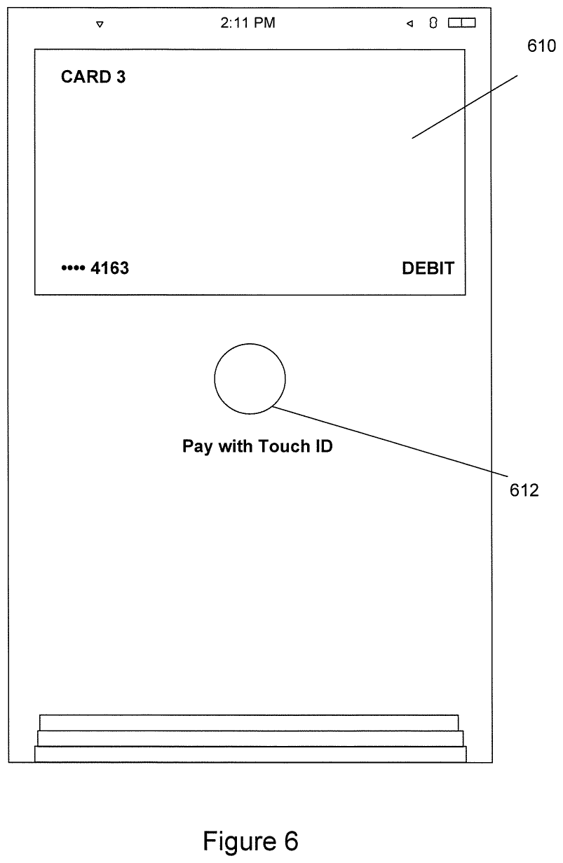

FIG. 6 is an exemplary screenshot illustrating a proximity based wallet interface, according to an embodiment of the present invention. The selected card may be displayed at 610. The customer may initiate an interaction, as shown by 612.

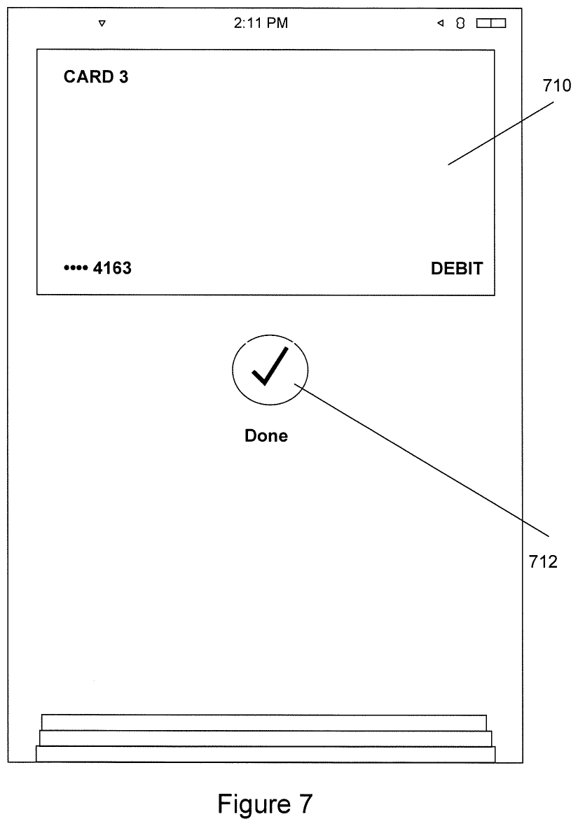

FIG. 7 is an exemplary screenshot illustrating a proximity based wallet interface, according to an embodiment of the present invention. FIG. 7 illustrates the card used during the transaction at 710. Upon completion, the application may provide a confirmation graphic at 712.

Although the foregoing description has focused primarily on a financial institution assembling relevant data sets, processing the data, and sending the relevant data at appropriate times to its customer, the system may be operated and maintained by other types of commercial entities who may configure the system to provide similar advantages to their customers. In additional, while the foregoing description has focused primarily on the customer spend, the principles of the invention can be applied to other vendors and entities where the operating entity can assemble and provide relevant, timely information to enhance the customer's experience.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Data and information maintained by the servers may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

Communications network, e.g., 140 in FIG. 1, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34b is analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network, e.g., 140 in FIG. 1, may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications Network 140 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network, e.g., 140, may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication network 110 may comprise a Personal Branch Exchange (PBX), which may further connect to the PSTN.

Although examples of a mobile device 110 are shown in FIG. 1, exemplary embodiments of the invention may utilize other types of communication devices whereby a user may interact with a network that transmits and delivers data and information used by the various systems and methods described herein. The mobile device and personal computing device may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The mobile device and personal computing device may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The mobile device and personal computing device may also include a network-enabled appliance or another TCP/IP client or other device. The mobile device 130 and personal computing device 120 may include various connections such as a cell phone connection, WiFi connection, Bluetooth connection, satellite network connection, and/or near field communication (NFC) connection, for example.

As described above, FIG. 1 may include a number of servers and user communication devices, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A mobile device comprising:
a memory component that stores customer data;
an application that executes on the mobile device that accesses a digital wallet application;
a display interface that receives customer input and generates display data; and
a microprocessor, coupled to the memory component, the display and the application, wherein the microprocessor is configured to perform the steps of:
identifying a signal transmitted from a beacon associated with an ATM, the signal indicating that the mobile device is within a predetermined proximity to the ATM;
responsive to the signal, providing a notification to a customer that an ATM is within the predetermined proximity;
requesting one or more card instruments from the digital wallet application;
receiving at least one card instrument that is eligible to interact with the ATM;
automatically presenting the at least one card instrument on the display interface; and
activating of the at least one card instrument for interaction with the ATM.

2. The financial device of claim 1, wherein the beacon comprises a Bluetooth Low energy beacon.

3. The mobile device of claim 1, wherein the signal comprises a universally unique identifier (UUID) and major and minor values.

4. The financial device of claim 1, wherein the at least one card instrument comprises a debit card.

5. The financial device of claim 1, wherein the microprocessor is further configured to perform the step of:
receiving authentication information from the customer.

6. The financial device of claim 5, wherein the authentication information comprises a biometric input from the customer.

7. The financial device of claim 1, wherein the customer selects from multiple card instruments displayed on the display interface.

8. The financial device of claim 1, wherein the digital wallet application stores additional payment instruments.

9. The financial device of claim 1, wherein the digital wallet makes an authorization request to the ATM.

10. The financial device of claim 9, wherein the ATM authorizes the interaction.

11. A method for implementing a mobile device application executing on a mobile device for proximity based digital wallet notifications, the method comprising the steps of:
identifying a signal transmitted from a beacon associated with an ATM, the signal indicating that the mobile device is within a predetermined proximity to the ATM;
responsive to the signal, providing a notification to a customer that an ATM is within the predetermined proximity;
requesting one or more card instruments from the digital wallet application;
receiving at least one card instrument that is eligible to interact with the ATM;
automatically presenting the at least one card instrument on a display interface; and
activating of the at least one card instrument for interaction with the ATM.

12. The method of claim 11, wherein the beacon comprises a Bluetooth Low energy beacon.

13. The method of claim 11, wherein the signal comprises a universally unique identifier (UUID) and major and minor values.

14. The method of claim 11, wherein the at least one card instrument comprises a debit card.

15. The method of claim 11, further comprising the step of:
receiving authentication information from the customer.

16. The method of claim 15, wherein the authentication information comprises a biometric input from the customer.

17. The method of claim 11, wherein the customer selects from multiple card instruments displayed on the display interface.

18. The method of claim 11, wherein the digital wallet application stores additional payment instruments.

19. The method of claim 11, wherein the digital wallet makes an authorization request to the ATM.

20. The method of claim 19, wherein the ATM authorizes the interaction.
